(19) United States
(12) Patent Application Publication
(10) Pub. No.: US 2007/0081415 A1
(43) Pub. Date: Apr. 12, 2007

(54) Electronic whisk

(76) Inventor: Addison Harewood, Monterey, CA (US)

Correspondence Address: JAMES RAY & ASSOCIATES, 2640 PITCAIRN ROAD, MONROEVILLE, PA, 15146, US

(21) Appl. No.: 11/546,215

(22) Filed: Oct. 11, 2006

Related U.S. Application Data
(60) Provisional application No. 60/725,596, filed on Oct. 11, 2005.

(51) Int. Cl. A47J 43/10

(52) U.S. Cl. 366/129

(57) ABSTRACT

An electronically operated whisk mechanism. Such whisk mechanism including a wire frame mixing portion having each of a first predetermined length and a predetermined number of wires. A generally hollow handle portion has a portion of the wire frame extending into a first end thereof. The generally hollow handle portion having a second predetermined length. There is a motor disposed in the generally hollow handle portion and connected to that portion of such wire frame mixing portion which extends into such first end of such generally hollow handle portion for causing rotation of the wire frame mixing portion. A power source is electrically connected to the motor and a switch is connected between the power source and such motor for controlling power to such motor.

### CROSS-REFERENCE TO RELATED APPLICATION

This application is related to and claims priority from U.S. Provisional Patent Application Ser. No. 60/725,596 filed Oct. 11, 2007.

### FIELD OF THE INVENTION

The present invention relates, in general, to whisks used for mixing preselected foods and, more particularly, this invention relates to a whisk that is operated electronically and which can be used effectively by handicap persons which are afflicted with various ailments such as arthritis.

### BACKGROUND OF THE INVENTION

Prior to the conception and development of the present invention, whisks have been known in the prior art and have been used extensively by housewives, cooks and chefs for several years. However, the commercially available whisks, which applicant is currently aware of, are quite difficult to use, particularly, by those persons who have certain physical handicaps.

Additionally, processing tool attachments for a food mixing device have been taught in the prior art. See, for example, U.S. Pat. No. 6,719,450 issued to Glucksman, et al., the teachings of which are incorporated herein by reference thereto.

This device is quite bulky, difficult to use, relatively expensive to manufacture and requires a considerable amount of storage space when not in use. Furthermore, because this device has a number of working parts it is more susceptible to excessive wear which can require considerable maintenance.

This device provides a blender equipped with a processing tool having a shaft and a body. There is a motor and a collet connected to the motor at a first end thereof disposed within the body. The collet is configured to couple the processing tool to the motor. Such collet includes a collet body and at least two extensions forming a shaft receiving portion at a second end thereof. The shaft of the processing tool is received in the shaft receiving portion forming a friction-fit engagement to secure the processing tool.

### SUMMARY OF THE INVENTION

The present invention provides an electronically operated whisk mechanism which includes a wire frame mixing portion having each of a first predetermined length and a predetermined number of wires. A generally hollow handle portion has a portion of the wire frame mixing portion extending into a first end thereof. Such generally hollow handle portion having a second predetermined length. A motor is disposed in such generally hollow handle portion and connected to the portion of such wire frame mixing portion that extends into the first end of such generally hollow handle portion for causing rotation of the wire frame mixing portion. There is a power source electrically connected to such motor and a switch means is connected between such power source and the motor for controlling power to such motor.

### OBJECTS OF THE INVENTION

It is, therefore, one of the primary objects of the present invention to provide an electronically operated whisk mechanism which is relatively easy to operate even by persons having certain physical disabilities.

Another object of the present invention is to provide an electronically operated whisk mechanism which is relatively inexpensive to manufacture.

Still another object of the present invention is to provide an electronically operated whisk mechanism which is relatively lightweight.

Yet another object of the present invention is to provide an electronically operated whisk mechanism which requires a relatively small storage area.

A further object of the present invention is to provide an electronically operated whisk mechanism which can be hung on a wall area.

An additional object of the present invention is to provide an electronically operated whisk mechanism which is battery powered.

Still yet another object of the present invention is to provide an electronically operated whisk mechanism which can be provided in different sizes.

In addition to the various objects and advantages of the present invention which have been described in some degree of specificity above, it should be noted that various additional objects and advantages of the present invention will become more readily apparent to those persons skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a side elevation view of a presently preferred embodiment of the electronically operated whisk device according to the present invention;

FIG. 2 is a side elevation view illustrating a portion of the handle having an on-off switch incorporated therein as well as a means for hanging the device on a wall;

FIG. 3 illustrates the battery for operating the whisk mechanism being inserted into the handle; and

FIG. 4 illustrates the electronically operated whisk device of the present invention being used.

### BRIEF DESCRIPTION OF A PRESENTLYPREFERRED AND VARIOUS ALTERNATIVE EMBODIMENTS OF THE INVENTION

Prior to proceeding to the more detailed description of the present invention it should be noted that, for the sake of clarity and understanding, identical components having identical reference numerals have been identified with identical reference numerals throughout the several views illustrated in the drawings figures.

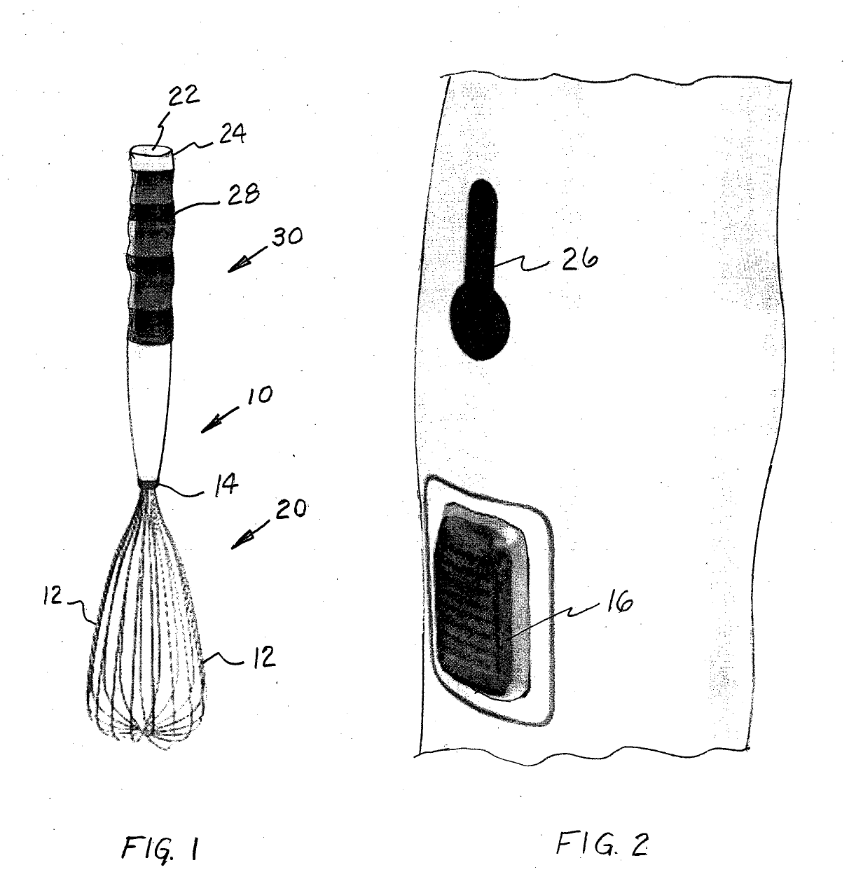

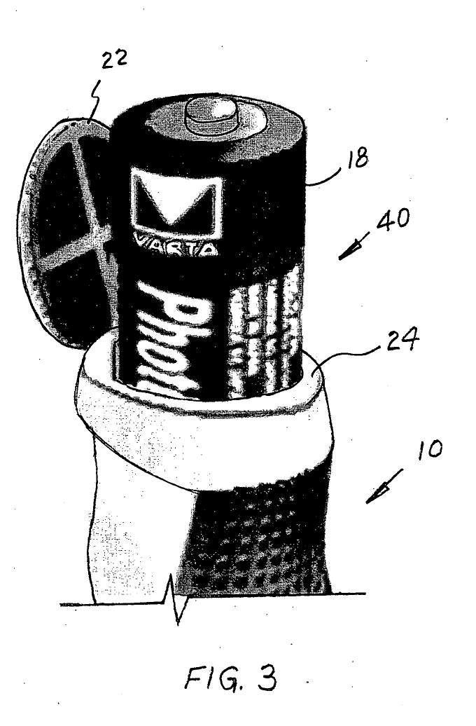

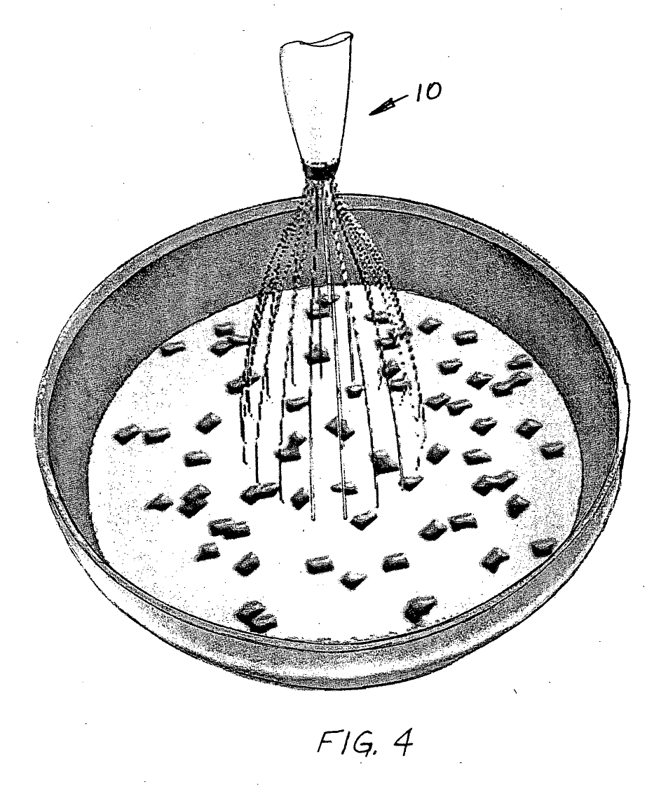

Reference is now made, more particularly, to FIGS. 1-4 of the drawings. Illustrated therein is one presently preferred embodiment of the electronically operated whisk mechanism, generally designated 10. The electronically operated whisk mechanism 10 includes a wire frame mixing portion, generally designated 20, having each of a first predetermined length and a predetermined number of wires 12.

There is a generally hollow handle portion, generally designated 30, having a portion (not shown) of such wire frame mixing portion 20 extending into a first end 14 of such generally hollow handle portion 20. Such generally hollow handle portion 30 having a second predetermined length.

Additionally, there is a motor (not shown) disposed in such generally hollow handle portion 30 and connected to such portion of the wire frame mixing portion 20 extending into such first end 14 of the generally hollow handle portion 30 for causing rotation of such wire frame mixing portion 20.

A power source, generally designated 40 is electrically connected to the motor and a switch means 16 is connected between such power source 40 and the motor for controlling power to such motor.

In the presently preferred embodiment of the invention, such power source 40 is at least one battery 18. The electronically operated whisk mechanism 10 further includes a cap like member 22 disposed at a second end 24 thereof to allow access to an interior portion thereof in order to install such at least one battery 18 therein.

In a most presently preferred embodiment of the electronically operated whisk mechanism 10 such generally hollow handle portion 30 further includes a means 26 formed through a side wall thereof for enabling the electronically operated whish mechanism 10 to be hung on a wall (not shown) when it is not in use. Additionally, such generally hollow handle portion 30 further includes a plurality of ridges 28 formed thereon for improved gripping of such electronically operated whisk mechanism 10 during use.

Further, in the presently preferred embodiment of the electronically operated whisk mechanism 10 such first predetermined length of the wire frame mixing portion 20 plus such second predetermined length of the generally hollow handle portion 30 are in a range of between about 5.0 inches to about 12.0 inches.

The at least one battery, in the presently preferred embodiment is selected from the group consisting of AA and C depending on the first predetermined length of such wire frame mixing portion 20 plus the second predetermined length of such generally hollow handle portion 30.

For example, when such at least one battery 18 is a AA size battery then such first predetermined length of the wire frame mixing portion 20 plus the second predetermined length of such generally hollow handle portion 30 will preferably be between about 5.0 inches and about 6.0 inches and when the at least one battery is a C battery then such first predetermined length of the wire frame mixing portion 20 plus the second predetermined length of such generally hollow handle portion 30 will be between about 10.0 inches and about 12.0 inches.

Finally it is preferred that such generally hollow handle portion 30 is formed as a molded part so that it can be molded in a variety of colors.

While in accordance with the Patent Statutes both a presently preferred and a number of alternative embodiments of the invention have been described in sufficient detail above to enable anyone skilled in the relevant art to make and use the same it is to be understood that various additional modifications and adaptations can be envisioned by such persons skilled in the art without departing from either the spirit of the invention or the scope of the appended claims.

I claim:

1. An electronically operated whisk mechanism, said whisk mechanism comprising:
(a) a wire frame mixing portion having each of a first predetermined length and a predetermined number of wires;
(b) a generally hollow handle portion having a portion of said wire frame extending into a first end thereof, said generally hollow handle portion having a second predetermined length;
(c) a motor disposed in said generally hollow handle portion and connected to said portion of said wire frame mixing portion extending into said first end of said generally hollow handle portion for causing rotation of said wire frame mixing portion;
(d) a power source electrically connected to said motor; and
(e) a switch means connected between said power source and said motor for controlling power to said motor.

2. An electronically operated whisk mechanism, according to claim 1, wherein said power source is at least one battery.

3. An electronically operated whisk mechanism, according to claim 2, wherein said generally hollow handle portion further includes a cap like member disposed at a second end thereof to allow access to an interior portion thereof in order to install said at least one battery therein.

4. An electronically operated whisk mechanism, according to claim 1, wherein said generally hollow handle portion further includes a means formed through a side wall thereof for enabling said electronically operated whish mechanism to be hung on a wall when not in use.

5. An electronically operated whisk mechanism, according to claim 1, wherein said generally hollow handle portion further includes a plurality of ridges for improved gripping of said electronically operated whisk mechanism during use.

6. An electronically operated whisk mechanism, according to claim 2, wherein said first predetermined length of said wire frame mixing portion plus said second predetermined length of said generally hollow handle portion are in a range of between about 5.0 inches to about 12.0 inches.

7. An electronically operated whisk mechanism, according to claim 6, wherein said at least one battery is selected from the group consisting of AA and C depending on said first predetermined length of said wire frame mixing portion plus said second predetermined length of said generally hollow handle portion.

8. An electronically operated whisk mechanism, according to claim 7, wherein said at least one battery is a AA battery and said first predetermined length of said wire frame mixing portion plus said second predetermined length of said generally hollow handle portion is between about 5.0 inches and about 6.0 inches.

9. An electronically operated whisk mechanism, according to claim 7, wherein said at least one battery is a C battery and said first predetermined length of said wire frame mixing portion plus said second predetermined length of said generally hollow handle portion is between about 10.0 inches and about 12.0 inches.

10. An electronically operated whisk mechanism, according to claim 1, wherein said generally hollow handle portion is formed as a molded part.

11. An electronically operated whisk mechanism, according to claim 10, wherein said molded generally hollow handle portion is molded in a variety of colors.
